(19) United States
(12) Patent Application Publication
(10) Pub. No.: US 2025/0062435 A1
(43) Pub. Date: Feb. 20, 2025

(54) BATTERY MODULE COMPRISING A FLUID APPLYING PRESSURE TO A CELL

(71) Applicant: AMPERE S.A.S., Boulogne Billancourt (FR)

(72) Inventors: Victor CHAUDOY, Guyancourt Cedex (FR); Thierry TOURRET, Guyancourt Cedex (FR)

(73) Assignee: AMPERE S.A.S., Boulogne Billancourt (FR)

(21) Appl. No.: 18/720,966

(22) PCT Filed: Dec. 12, 2022
(86) PCT No.: PCT/EP2022/085303

§ 371 Date: Jun. 17, 2024

(30) Foreign Application Priority Data
Dec. 20, 2021 (FR) FR2113978

(51) Int. Cl. H01M 10/613; H01M 10/04; H01M 10/0525; H01M 10/625; H01M 10/6555; H01M 10/6557; H01M 50/204

(52) U.S. Cl. CPC H01M 10/613; H01M 10/0481; H01M 10/625; H01M 10/6555; H01M 10/6557; H01M 50/204; H01M 10/0525; H01M 2220/20

(57) ABSTRACT

A module for a battery includes an enclosure, cells arranged within the enclosure, a space formed between the first main face of a cell and the second main face of an adjacent cell, the fluid occupying the space or spaces so as to cool the first main faces and/or the second main faces. The module includes flexible walls each extending facing and in contact with the first main face or the second main face of a cell and the flow rate of the fluid being controlled so as to make it possible to vary a pressure of the fluid applied to the flexible walls.

### TECHNICAL FIELD OF THE INVENTION

The invention relates to a module for a battery. The invention relates also to a battery comprising such a module. The invention relates also to a system comprising such a module or such a battery. The invention relates also to a vehicle comprising such a system or such a battery or such a module. The invention relates also to a method for operating such a system.

### STATE OF THE PRIOR ART

An electric or hybrid vehicle, for example a motor vehicle, generally comprises a battery. Such a battery, for example a traction and/or propulsion battery, generally comprises one or more modules. Such modules each comprise at least one electrochemical electrical energy storage cell, of lithium-ion type for example.

A cell, in particular of Lithium-Ion type, of a battery module undergoes volume variations throughout its life. More specifically, during charge/discharge cycles, the volume of a cell varies respectively by inflating and shrinking. Such changes of volume are particularly consequential in the case of the use of certain materials in the cell, in particular silicon. In addition, as a cell ages, it inflates little-by-little without shrinking.

Furthermore, a cell undergoes temperature variations. Indeed, during its charging in particular, a cell can heat up. This increase in temperature, in particular at its connections, is consequential during rapid recharges, generally obtained from high currents. Thus, such a cell needs to be cooled to maximize its performance levels, particularly in terms of autonomy and recharging time.

Thus, it is particularly difficult to simultaneously manage the thermal conditioning and the inflations/deflations of the cells of a battery module.

The document KR10-2256604 describes a battery module that aims to both control the inflation of the cells and the cooling thereof with a compact structure. This module comprises a plurality of “buffers” disposed between the cells, the buffers being pockets made of an elastic material filled with a phase-change material, The elastic buffers are compressed when the cells inflate, the phase-change material being capable of controlling their temperature. The main drawback with this solution is notably that it involves a passive system operating independently of the real state of the cells, whether that be their short-term state in terms of charge or of temperature, or else their long-term state in terms of state of ageing and/or state of health.

### PRESENTATION OF THE INVENTION

The aim of the invention is to provide a module that resolves the issues of inflation/deflation and of thermal conditioning of the cells. Furthermore, the invention proposes a system that can be controlled as a function of the state of the cells.

### SUMMARY OF THE INVENTION

To achieve this objective, the invention relates to a module for a battery, notably of a vehicle, the module comprising:
an enclosure,
cells arranged in the enclosure, each cell comprising a first main face and a second main face,
a space formed between the first main face of a cell and the second main face of an adjacent cell and/or a space formed between one of the first and second main faces of a cell and the enclosure,
a fluid intake means and a fluid evacuation means, the fluid occupying the space or spaces so as to cool the first main faces and/or the second main faces, the module comprising flexible walls each extending facing and in contact with, or substantially in contact with, the first main face or the second main face of a cell and the flow rate of the fluid being controlled so as to make it possible to vary a pressure of the fluid being applied to the flexible walls on the first main faces and/or on the second main faces of the cells, in order to follow a shrinkage and/or an inflation of the cells during the charge/discharge cycles of the cells and/or in the course of the ageing of the cells.

A flexible wall extending facing a first main face of a cell and a flexible wall extending facing a second main face of an adjacent cell can be of a single piece and can form only a single membrane.

At least one flexible wall can be made of polymer, possibly covered at least partially by a plate on the side of its contact with a cell, the plate being able to be obtained from a material that is more conductive of heat than the polymer, notably a metal, or at least one flexible wall can comprise an insert in rectangular plate form obtained from a material that is more conductive of the heat than the polymer, notably a metal.

The module can comprise a first holding means for each membrane and a second holding means for each membrane, so as to stretch each membrane facing the first main face of a cell and facing the second main face of an adjacent cell, or so as to stretch each membrane facing the first main face or the second main face of a cell and facing the enclosure.

Each first holding means for each membrane can be cylindrical, notably of tube type, and/or each second holding means for each membrane can be cylindrical notably of tube type, each membrane being able to encircle, notably partially, the first holding means and the second holding means.

The enclosure can comprise a top part, notably a top part comprising the fluid evacuation means, and a bottom part, notably a bottom part comprising the fluid intake means, the top part and the bottom part being able to be arranged so as to transmit the fluid from the bottom part to the spaces and then to the top part.

The top part can comprise a first positioning means for the first and second holding means and the membranes and/or the bottom part can comprise a second positioning means for the first and second holding means and the membranes.

The invention relates also to a battery comprising at least one module as defined previously.

The invention relates also to a system comprising a module as defined previously or a battery as defined previously, the system comprising:
a pump for the fluid and means for controlling parameters of the pump, notably the activation and/or deactivation thereof and/or the flow rate thereof,
a means for determining the pressure of the fluid, notably in the enclosure,
a means for measuring the temperature at the module and/or at the enclosure and/or at at least one cell.

The invention relates also to a vehicle, notably a motor vehicle, comprising a system as defined previously or a battery as defined previously or a module as defined previously.

The invention relates also to a method for operating a system as defined previously, the method comprising a step of activation of the pump so as to obtain a fluid flow rate creating a pressure applied to at least one flexible wall facing a first main face of a cell and/or to at least one flexible wall facing a second main face of a cell.

The method can comprise:
a step of determination of the pressure of the fluid by the pressure determination means and/or a step of measurement of a temperature by the temperature measurement means,
a step of controlling of the flow rate of the pump by the controlling means as a function of the determined pressure of the fluid and/or of the measured temperature so as to maintain a pressure that is constant or substantially constant on at least one first main face and/or at least one second main face of a cell.

### PRESENTATION OF THE FIGURES

These objects, features and advantages of the present invention will be explained in detail in the following description of an embodiment and of a mode of execution of an operating method given in a nonlimiting manner in relation to the attached drawings in which:

FIG. 1 is a schematic view of a vehicle according to an embodiment.

FIG. 2 is a schematic view of a system according to an embodiment.

FIG. 3 is a partial perspective view of a battery module according to an embodiment.

FIG. 4 is a partial detail view of the battery module according to the embodiment.

FIG. 5 is a perspective view of membranes of the battery module according to the embodiment.

FIG. 6 is a perspective view of membranes of the battery module according to a variant embodiment.

FIG. 7 is a top schematic view of the battery module according to the embodiment.

FIG. 8 is a partial top schematic view of a cell, of a membrane and of a space according to the embodiment, the cell not being inflated.

FIG. 9 is a partial top schematic view of a cell, of a membrane and of a space according to the embodiment, the cell being inflated.

FIG. 10 is a partial cross-sectional schematic view of a module according to the embodiment.

### DETAILED DESCRIPTION

The direction in which a vehicle, notably a motor vehicle, moves in a straight line is defined as being the longitudinal direction X. By convention, the direction at right angles to the longitudinal direction, situated in a plane parallel to the ground, is called transverse direction Y. The third direction, at right angles to the other two, is called vertical direction Z. Thus, a direct reference frame XYZ is used in which X is the longitudinal direction from the front to the rear of the vehicle, therefore directed to the rear, Y is the transverse direction directed to the right and Z is the vertical direction directed upward. The forward direction corresponds to the direction in which the vehicle moves usually in the longitudinal direction and is opposite to the reverse direction.

As illustrated in FIG. 1, a vehicle 100, for example a motor vehicle, comprises an electrical energy storage means of battery type 101. The vehicle, or the battery 101, comprises at least one module 1. Preferably, the battery 101 comprises several modules 1, for example arranged side-by-side, for example by being in contact or substantially in contact with one another. Each module 1 comprises at least one cell 8, preferably several cells 8. Each cell 8 comprises a first main face 8A and a second main face 8B. Advantageously, each cell is, or is substantially, a rectangular parallelepiped and the first and second main faces 8A, 8B are the two largest faces of the parallelepiped. In this case, the faces 8A, 8B of each cell are parallel pairwise.

The vehicle 100 comprises a system 40.

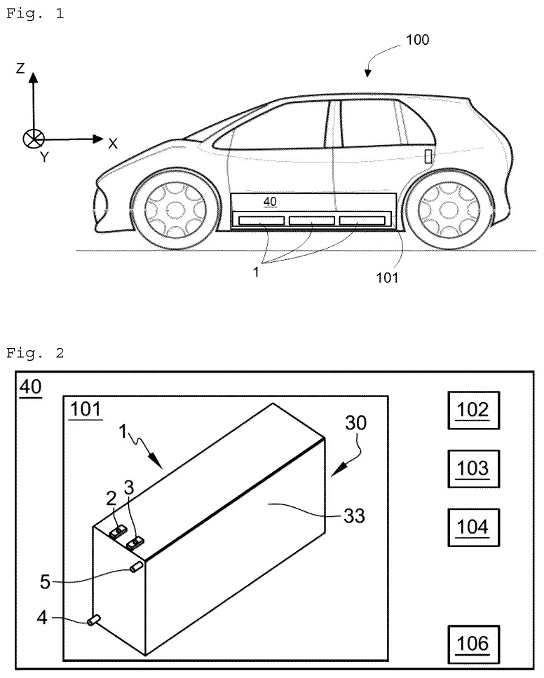

More specifically, as illustrated in FIG. 2, the system 40 comprises a module 1 and/or a battery 101. A fluid F, preferably a liquid, for example of glycol water type, is present in the module 1 as will be explained hereinbelow.

The system also comprises a pump 102 for the fluid F and a means 103 for controlling parameters of the pump 102. For example, these parameters comprise the activation of the pump 102 and/or the deactivation of the pump 102 and/or the level of flow rate of the pump 102. The pump controlling means uses, for example, a pulse width modulation (known by the abbreviation PWM). Thus, by modulating the pulses, the frequency and consequently the flow rate of the fluid are modulated.

Advantageously, a flowmeter complements the controlling means. Preferably, the system 40 also comprises a means 104 for measuring the temperature at the module 1 and/or at at least one cell 8. The temperature measurement means 104 preferably comprises one or more thermocouples. Advantageously, the system 40 comprises a means 106 for determining the pressure of the fluid. The determination means 106 measures, for example, the pressure exerted by the cell via the head loss of the hydraulic network, that is to say the drop in flow rate of the fluid F. Preferably, the controlling means 103 of the pump 102 is servocontrolled by the pressure determination means 106 so as to keep the pressure of the fluid F constant, or substantially constant, in the module. Preferably, the pump controlling means 103 comprises software means for tracking the flow rate and for managing the pump by PWM. It should be noted that several pumps can be arranged on a same circuit.

Alternatively, the system 40 comprises several modules 1 connected to one another electrically. Alternatively, or in addition, the system 40 comprises several modules 1 using the same volume of fluid, the modules having hydraulic connections between them, the system 40 comprising a single pump or several pumps.

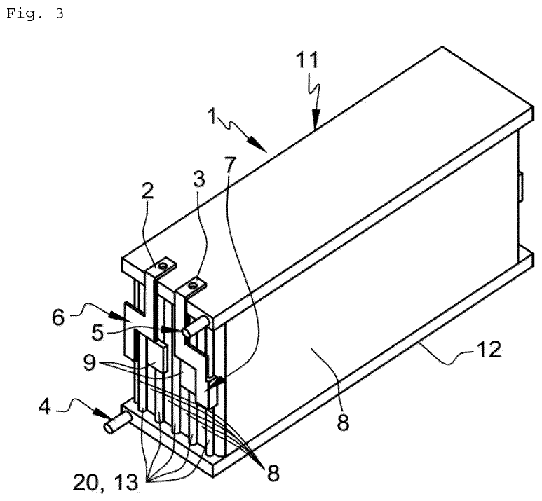

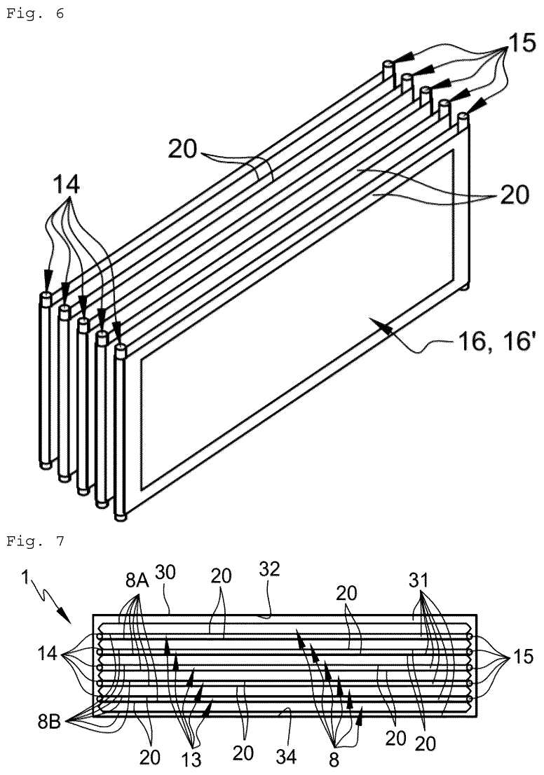

More specifically, as illustrated in FIG. 2, the module 1 comprises an enclosure 30. In the case of a cell 8 of parallelepiped form, the enclosure 30 also has a parallelepiped form. The enclosure 30 jackets all of the cells 8 of the module 1. As illustrated in FIG. 7, in the enclosure 30, the cells 8 are arranged such that the first main face 8A of a cell 8 is parallel to a second main face 8B of an adjacent cell 8. Preferably, the first main face BA of a cell 8 adjacent to the enclosure 30 extends facing an inner face 32 of the enclosure 30. Preferably, the second main face 8B of a cell 8 adjacent to the enclosure 30 extends facing an inner face 34 of the enclosure 30. The inner faces 32, 34 of the enclosure 30 are parallel, of the same dimensions, or substantially of the same dimensions, and facing one another when the enclosure is empty. Preferably, as illustrated in FIGS. 2 and 3, the module 1 comprises terminals 2, 3, for example a positive terminal and a negative terminal, extending for example above the module 1. For example, in the embodiment illustrated in FIG. 3, the terminal 2 is linked to, or comprises, a connection means 6, preferably of “busbar” type. Likewise, for example, the terminal 3 is linked to, or comprises, a connection means 7, preferably of “busbar” type. Preferably, the module 1 comprises at least one connection means or connection system 9 between the module cells 8. For example, the terminals 2, 3 allow the module 1 to be electrically connected to another module, preferably another adjacent module.

As illustrated in particular in FIGS. 7, 8, 9 and 10, a space 31 is formed between the first main face 8A of a cell 8 and the second main face 8B of an adjacent cell 8. Preferably, a space 31 is formed between the first main face 8A of a cell 8 adjacent to the enclosure 30 and the inner face 32 of the enclosure 30. Preferably, a space 31 is formed between the second main face 8B of a cell 8 adjacent to the enclosure 30 and to the inner face 34 of the enclosure 30.

As illustrated in FIGS. 2 and 3, the module 1 also comprises a fluid F intake 4, or input, or inlet. Preferably, the fluid F is a coolant. The module 1 also comprises a fluid F evacuation means 5, or outlet, or exhaust. Thus, the fluid that allows the management of the inflation as will be seen hereinbelow, and the cooling of the cells, enters into the module 1 at the input 4 and exits from the module 1 through the outlet 5. Alternatively, the fluid circulates in the reverse direction.

The fluid F occupies the spaces 31 so as to cool the first main faces 8A and the second main faces 8B. The flow rate of the fluid F is controlled so as to make it possible to vary the pressure P applied to the first main faces 8A and to the second main faces 8B of the cells 8. Thus, by varying the pressure of the fluid F, a deflation or an inflation of the first and second main faces of the cells 8 is followed. In other words, the pressure applied to the main faces 8A, 8B of the cells is varied during the charge/discharge cycles of the cells and in the course of the life of the cells.

As illustrated in FIGS. 3 to 10, the module 1 comprises flexible walls 13 each extending facing the first main face 8A or the second main face 8B of a cell 8. Advantageously, the flexible walls 13 each extend facing, and in contact or substantially in contact with, the first main face 8A or the second main face 8B of each cell 8. The walls are flexible, and preferably elastic. Thus, a flexible wall 13, of thin band or sheet type, is distinct from the cell 8 against which the flexible wall 13 extends. In other words, each flexible wall 13 is affixed to, or covers, at least partially, the first main face 8A or the second main face 8B of a cell 8.

For example, two flexible walls 13 extend between two holding means 14, 15. In this case, each flexible wall 13 is for example fixed to a holding means 14 on one side, and to a holding means 15 on the other side.

Thus, more specifically, the spaces 31 between two adjacent cells, or the space or spaces between a cell and an inner face 32, 34 of the enclosure 30, extend between the flexible walls 13.

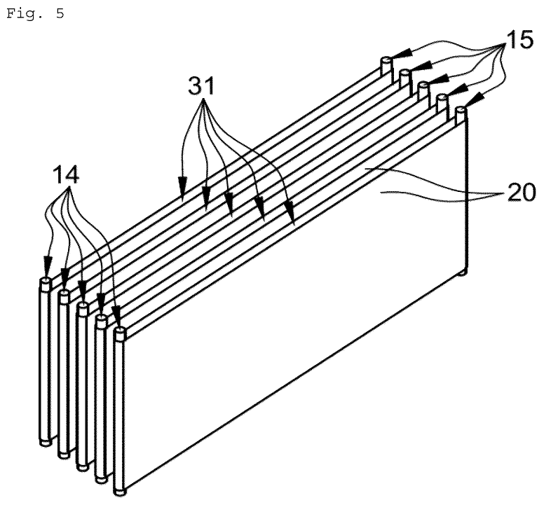

Advantageously, each flexible wall 13 is made of polymer. Preferably, the polymer used is flexible so as to allow a change of form of the wall under a level of pressure P of the fluid F as well as under the pressure due to the inflation of the cells. For example, according to a variant of the embodiment illustrated in FIG. 6, at least one wall 13 is covered, at least partially, by a plate 16 on the side of its contact with a cell 8. In this case, the wall 13 comprises the plate 16 of rectangular form for example. Preferably, the plate 16 is obtained from a material that is more conductive of heat than the polymer. Advantageously, the material of the plate 16 is a metal, for example copper or even an alloy including copper.

Alternatively, at least one wall 13 comprises an insert 16′ in rectangular plate form obtained from a material that is more conductive of heat than the polymer, for example a metal, for example copper or containing copper. The term “insert” is understood to mean that the wall 13 comprises, over the entire area or substantially the entire area receiving the insert 16′, only the insert 16′. In other words, the insert 16′ replaces the material of the wall 13 over the entire surface of the insert.

Advantageously, the area of a plate 16, or of an insert 16′, is substantially equal to the area of a main face 8A, 8B of a cell. A plate 16 or an insert 16′ comes to face, fully or substantially fully, and be in contact or substantially in contact with, a main face 8A, 8B of a cell.

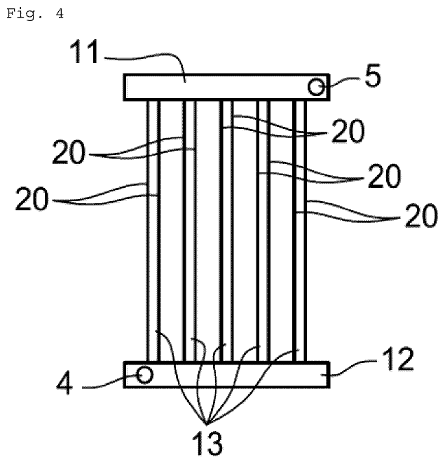

Preferably, as illustrated in FIGS. 7 to 9, a wall 13 extending facing a first main face 8A of a cell 8 and a wall 13 extending facing a second main face 8B of an adjacent cell 8 (not illustrated) are made of a single piece. Thus, the two walls 13 form a single membrane 20. Advantageously, as illustrated in particular in FIGS. 4 to 9, each membrane has a sleeve form stretched between two holding means 14, 15. Thus, a membrane 20 is distinct from the cell or cells against which the membrane 20 extends. In other words, each membrane 20 is affixed to, or covers, at least partially, the first main face 8A or the second main face 8B of a cell 8. Preferably, a same membrane 20 is affixed to, or covers, at least partially, the first main face 8A of a cell and the second main face 8B of an adjacent cell, as illustrated in particular in FIG. 7.

The contact of two walls 13 on either side of a cell, or of two membranes 20 on either side of a cell 8, makes it possible to apply a pressure P of the fluid F to the first and second main faces 8A, 8B of the cells. In effect, to recap, the fluid F occupies the spaces 31 that then extend within the membranes 20. In the case of an insert 16′ or plate 16 on the walls 13 or membranes 20, the capacity for transmission of heat from the faces 8A, 8B of the cells 8 to the inserts 16′ or the plates 16, then from the inserts 16′ or the plates 16 to the fluid, contributes to improving, to assisting in, the cooling of the cells. In other words, the calories produced by the cells are transferred rapidly to the fluid F which dissipates them by virtue of the ongoing circulation of the fluid F.

As illustrated in FIGS. 5, 6, 7, 8 and 9, the module 1, or enclosure 30, comprises a first holding means 14 for each membrane 20 and a second holding means 15 for each membrane 20. The first and second holding means 14, 15 are arranged so as to stretch a membrane 20 facing the first main face 8A of a cell 8 and facing the second main face 8B of an adjacent cell 8. Alternatively, the first and second holding means 14, 15 are arranged so as to stretch a membrane 20 facing the first main face 8A and the inner face 32 of the enclosure 30, or facing the second main face 8B and the inner face 34 of the enclosure 30. Preferably, each first holding means 14 for each membrane 20 is cylindrical, for example of tube or solid cylindrical shaft type. Preferably, each second holding means 15 for each membrane 20 is cylindrical, for example of tube or solid cylindrical shaft type. Thus, for example, each membrane 20 at least partially encircles the first holding means 14 and the second holding means 15. In the case of holding means 14, 15 of circular section, as illustrated in FIGS. 5 to 9, a membrane 20 encircles or jackets substantially half the outer surface of the holding means 14, 15 which keep it taut. Preferably, the holding means are rigid, for example obtained based on a metallic material or composite materials, so as to obtain a high mechanical strength compatible with the tension to which the walls 13 or membranes 20 are subjected by the holding means 14, 15.

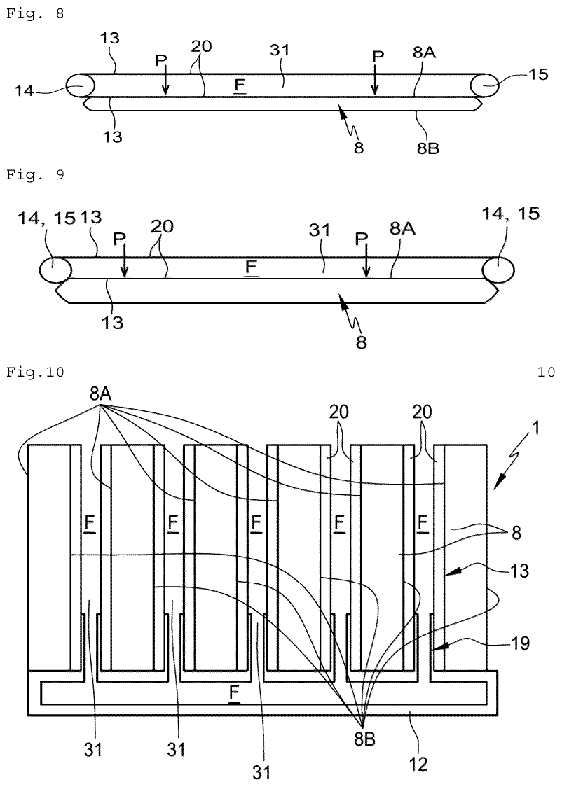

As will be explained hereinbelow, in the case of a phase of shrinkage or deflation of the cell 8, the membrane 20 encircles the holding means 14, 15 over half or substantially half of their outer surface (FIG. 8). On the other hand, in the case of a phase of inflation of the cell 8 when the cell is being charged or in the case of an inflated cell, the membrane 20 encircles the holding means 14, 15 beyond the half of their outer surface (FIG. 9—in the case of a cell adjacent to the cell illustrated and therefore also in contact with the membrane 20 illustrated, the membrane is deformed on both sides and not just one side as illustrated here with a single cell).

As illustrated in FIGS. 3 and 4, the module 1 or the enclosure 30 also comprises a top part 11. Advantageously, the top part 11 comprises the fluid F evacuation means 5. The module 1 or the enclosure 30 also comprises a bottom part 12. Advantageously, the bottom part 12 comprises the fluid F intake means 4. Generally, the top part 11 and the bottom part 12 are arranged so as to transmit, promote even the transmission of, the fluid from the bottom part 12 to the spaces 31 and then to the top part 11. In other words, the parts 11, 12 comprise ducts and/or channels and/or cavities that make it possible to ensure the flow of the fluid from the inlet 4 to the spaces 31 and from the spaces 31 to the outlet 5.

Preferably, the top part 11 comprises a first positioning means for the first and second holding means 14, 15 and/or the membranes 20. Preferably, as illustrated in FIG. 10, the bottom part 12 comprises a second positioning means 19 for the first and second holding means 14, 15 and/or the membranes 20. The first positioning means and the second positioning means for the holding means 14, 15 and/or for the membranes 20 are for example made of a piece with the top part 11, respectively with the bottom part 12, as illustrated in FIG. 10. For example, the first and second positioning means hold the holding means 14, 15 and/or the membranes 20 in position, even seal the holding means 14, 15 and/or the membranes 20. For example, the walls 13 or membranes 20 are sealed on the first and second positioning means for the holding means, for example by gluing or by laser welding. The tubes 14, 15 are for example arranged, inserted, in locations provided in the top part 11 and in the bottom part 12. The walls 13 or membranes 20 are also arranged in notches, or protuberances or cavities formed to hold them in the top part 11 and the bottom part 12. Alternatively, the walls 13 or membranes 20 are welded onto zones of the bottom and top parts 12, 11.

It should be noted that all of the elements comprising the fluid F for the management of the pressure P on the faces of the cells and the thermal conditioning of the cells are leaktight and withstand a maximum threshold pressure that can be reached by the fluid in these elements.

A mode of execution of a method for operating the system 40 will now be described.

The method for operating the system 40 comprises a step of activation of the pump 102 so as to obtain a fluid F flow rate creating the pressure P applied to the first main faces 8A and to the second main faces 8B of the cells 8.

Advantageously, the method comprises, in a first step, a step of determination of the pressure P of the fluid F by the pressure determination means 106, preferably in the enclosure. Alternatively, or in addition, the method comprises a step of measurement of a temperature by the temperature measurement means 104.

Next, there is a step of controlling of the flow rate of the pump 102 by the controlling means 103 as function of the determined pressure of the fluid and/or of the measured temperature. This controlling is performed so as to keep the pressure P constant, or substantially constant, on the first main faces 8A and on the second main faces 8B of the cells.

By virtue of their elasticity, the walls 13 or membranes 20 can be deformed because of the inflation of the cells. These deformations alter the volume of the spaces 31. In the case of inflation of the cells, the volume of the spaces 31 is lowered. In case of deflation of the cells, the volume of the spaces 31 is increased. Preferably, the pressure P applied to the cells through the fluid injected into the enclosure aims only to “follow” the inflation/deflation of the cells. In other words, the pressure P being applied to the walls or membranes and being reflected on the faces 8A, 8B of the cells, and possibly on the inner faces 32, 34 of the enclosure 30, accompanies the inflation of the cells and, if necessary, the deflation of the cells.

Thus, in the case of inflation of the cells, notably linked to the electrical charge of the cells, the volume of the sum of the spaces 31 is lowered. The fluid pressure determination means 106 observes an increase of pressure. The pump 102 is then controlled to lower the pressure of the fluid in order to return to a target value in the module 1. Conversely, in the case of deflation of the cells, notably linked to the electrical discharge of the cells created by the consumption of electrical energy stored in the battery 101, the volume of the spaces 31 increases. The pressure determination means 106 observes a lowering of pressure. The pump 102 is then controlled to increase the pressure of the fluid in order to return to a target value in the module 1.

To sum up, the solution makes it possible to apply a pressure that is constant and continuous to the first and second main faces of the cells of a battery module even though these cells inflate and shrink variably. Furthermore, the solution makes it possible to cool the cells via the fluid which makes it possible to discharge calories. Thus, the solution makes it possible to manage the inflation/shrinkage of one cell or several cells, notably electrochemical cells, during cycles of charge/discharge type, and throughout the life of such cells.

The result thereof is that the enclosure 30 of the module, notably its walls 33 (FIG. 2), possibly inserted into a housing or casing for receiving a battery, does not undergo deformation generated by the inflations. When the cells inflate, the pressure of the fluid F is lowered, notably by lowering of the flow rate of the pump, and the enclosure 30 is not impacted in terms of deformations.

The use of the walls and/or membranes also makes it possible to limit the quantity of fluid used.

Advantageously, the pressure is applied only to the first and second main faces of the cells. In fact, advantageously, the cells are not immersed in the fluid. In this case, the electrical connection systems of the cells are not subjected to the pressure. Advantageously, the membranes 20 and the bottom and top parts 12, 11 are arranged so as to contain, store, the fluid. Thus, it is if necessary possible to change a cell, even to remove the cells, notably by opening the module, without any leak or loss of the fluid.

By virtue of the solution, Lithium-Ion cells that have an inflation during their ageing and in the course of the various charge and discharge cycles are kept at a certain pressure in their enclosure, in particular on their main faces. That is particularly advantageous for cells that have a strong volume variation during the different charge/discharge cycles. Such is the case for cells comprising materials that increase their energy density and/or have a high specific capacity, for example based on silicon. These reversible expansions/contractions during charges/discharges of the cell, and the irreversible expansion linked to the ageing are managed by the monitoring or management of the fluid circulating in the module. Furthermore, in the case of a rapid charge involving high currents generating overheating in the cell, in particular at the electrical connection system, the fluid cools the cells by cooling their various faces. Thus, the presence of the fluid whose pressure is monitored in the module makes it possible to adapt to the inflations of the cells while controlling the changes of temperature of the cells.

In other words, the solution makes it possible to adapt to the inflation of the cells in “cycling” and in ageing by adjusting the internal pressure of the module. Indeed, through the controlling of the pressure of the fluid, the internal pressure changes as a function of the state of charge of the cell or cells. The reduction of pressure of the fluid F makes it possible to let the cells 8 inflate (FIG. 9) while the increase of pressure of the fluid F makes it possible to tolerate the absence of inflation, or substantially the absence of inflation, of the cells 8 (FIG. 8). Thus, the inflation of the cells is followed by adjusting the pressure of the fluid.

The solution also makes it possible to deduce the level of inflation of the cells and possibly estimate the age of the cells. Indeed, by instrumenting the system, notably with the fluid pressure determination means 106 and/or the temperature measurement means 104, it becomes possible to interpret a command to increase pressure or to lower pressure to the fluid transfer pump 102. To recap, the solution aims to maintain a pressure that is constant, or substantially constant, on the cells, in particular on the main faces 8A, 8B of the cells 8 in order to adapt to the general inflation. “General inflation” is understood to mean the association of the inflation of the cells due to the ageing of the cells and the inflation due to the charging of the cells with electrical energy. Thus, the solution offers a means for determining the state of the cells.

By virtue in particular of the walls 13 or membranes 20 in contact or substantially in contact with the faces 8A, 8B of the cells, the solution makes it possible to apply a continuous pressure to the assembly of cells, in particular to each first main face and/or to each second main face and to do so in a manner that can be set, adjusted, in particular as a function of the rigidity of the walls 13 or membranes 20.

The solution makes it possible to avoid having the walls of the enclosure 30 be deformed, or be deformed beyond a threshold, because of the inflation of the cells. Indeed, in the case of inflation of the cells 8, the flow rate of the pump 102 is decreased so as to let the cells be deformed without creating any repercussions on the walls of the enclosure 30. Conversely, when the cells deflate, the flow rate of the pump is increased. It should be noted that the circulation of the fluid, preferably continuous, also makes it possible to control, even limit, the changing or increasing of the temperature of the cells. Thus, the circulation of the fluid contributes to maintaining a constant pressure on the cells while ensuring a cooling function. Obviously, in the case of presence of plates 16 or insert 16′ on the walls 13 or membranes 20 made of material that is more conductive of heat, a better heat exchange between the cells and the fluid accelerates the cooling of the cells.

It should be noted that the solution is compatible with different types of materials, both for positive electrodes and negative electrodes, and/or for all-solid battery technologies (batteries with a solid electrolyte) or even the conventional Lithium-Ion batteries (generally with a liquid electrolyte).

The solution is particularly suited to a battery module of an electric or hybrid vehicle or even a vehicle comprising a heat engine equipped with a battery, notably with a voltage of the order of 48 V. The vehicle can be a bus, a two-wheeler, or other type of vehicle. Alternatively, the solution can be used in a battery intended to be stationary or even in a battery intended to power electronic and/or electrical devices, notably portable devices.

Note that the solution according to the invention therefore achieves the objective sought of providing a battery module that is compatible with the inflations/deflations of the cells while ensuring a thermal conditioning of the cells. Furthermore, the performance levels of the cells, in particular in terms of autonomy and recharge speed, are improved.

1-12. (canceled)

13. A module for a battery, the module comprising:
an enclosure;
cells arranged in the enclosure, each of the cells comprising a first main face and a second main face;
a space formed between the first main face of a cell and the second main face of an adjacent cell and/or a space formed between one of the first and second main faces of a cell and the enclosure;
a fluid intake means and a fluid evacuation means, the fluid occupying the space or spaces so as to cool the first main faces and/or the second main faces; and
flexible walls each extending facing and in contact with, or substantially in contact with, the first main face or the second main face of a cell, and a flow rate of the fluid is driven so as to make it possible to vary a pressure of the fluid being applied to the flexible walls on the first main faces and/or on the second main faces of the cells, in order to follow a shrinkage and/or an inflation of the cells during charge/discharge cycles of the cells and/or in the course of the ageing of the cells.

14. The module as claimed in claim 13, wherein a flexible wall extending facing a first main face of a cell and a flexible wall extending facing a second main face of an adjacent cell are made of a single piece and form only a single membrane.

15. The module as claimed in claim 13, wherein at least one of the flexible walls is made of polymer.

16. The module as claimed in claim 15, wherein at least one of the flexible walls is covered at least partially by a plate on the side of its contact with a cell, the plate being obtained from a material that is more conductive of heat than the polymer.

17. The module as claimed in claim 16, wherein the material of the plate is a metal.

18. The module as claimed in claim 15, wherein at least one of the flexible walls comprises an insert in rectangular plate form obtained from a material that is more conductive of heat than the polymer, notably a metal.

19. The module as claimed in claim 14, further comprising a first holding means for each membrane and a second holding means for each membrane,
wherein the first and second holding means are configured to stretch each membrane facing the first main face of a cell and facing the second main face of an adjacent cell, or
wherein the first and second holding means are configured to stretch each membrane facing the first main face or the second main face of a cell and facing the enclosure.

20. The module as claimed in claim 19, wherein each first holding means for each membrane is cylindrical and/or each second holding means for each membrane is cylindrical each membrane encircling, at least partially, the first holding means and the second holding means.

21. The module as claimed in claim 20, wherein at least one of the first and holding means is a tube.

22. The module as claimed in claim 13, wherein the enclosure comprises a top part and a bottom part, the top part and the bottom part being arranged so as to transmit the fluid from the bottom part to the spaces and then to the top part.

23. The module as claimed in claim 22, wherein the top part comprises the fluid evacuation means and the bottom part comprises the fluid intake means.

24. The module as claimed in claim 19,
wherein the enclosure comprises a top part and a bottom part, the top part and the bottom part being arranged so as to transmit the fluid from the bottom part to the spaces and then to the top part, and
wherein the top part comprises a first positioning means for the first and second holding means and the membranes and/or the bottom part comprises a second positioning means for the first and second holding means and the membranes.

25. A battery, comprising:
the module as claimed in claim 13.

26. A system, comprising:
the module as claimed in claim 13;
a pump for the fluid and means for controlling parameters of the pump;
means for determining a pressure of the fluid; and
means for measuring a temperature at at least one of the module, the enclosure, and the cell.

27. A vehicle, comprising:
the module as claimed in claim 13.

28. A method for operating the system as claimed in claim 26, comprising:
activating the pump so as to obtain a fluid flow rate creating a pressure applied to at least one flexible wall facing a first main face of a cell and/or to at least one flexible wall facing a second main face of a cell.

29. The method as claimed in claim 28, further comprising:
determining the pressure of the fluid by the pressure determining means and/or measuring the temperature by the temperature measuring means; and
controlling the flow rate of the pump by the controlling means as a function of the determined pressure of the fluid and/or of the measured temperature so as to maintain a pressure that is constant or substantially constant on at least one first main face and/or on at least one second main face of a cell.
